(19) United States
(12) Patent Application Publication
(10) Pub. No.: US 2026/0129355 A1
(43) Pub. Date: May 7, 2026

(54) HEADREST FOR PROVIDING INDEPENDENT SOUND ZONES

(71) Applicant: AAC Microtech (Changzhou) Co., Ltd., Changzhou City (CN)

(72) Inventors: Shuyuan Sun, Changzhou (CN); Yiming Meng, Changzhou (CN); Xin Zhang, Changzhou (CN); Xiang Huang, Changzhou (CN)

(21) Appl. No.: 19/169,021

(22) Filed: Apr. 3, 2025

Related U.S. Application Data
(63) Continuation of application No. PCT/CN2024/129429, filed on Nov. 1, 2024.

(51) Int. Cl. H04R 1/32; H04R 1/02

(52) U.S. Cl. CPC H04R 1/323; H04R 1/025; H04R 2499/13

(57) ABSTRACT

A headrest for providing independent sound zones includes a headrest body and a sound radiation system. The sound radiation system includes an acoustic transducer and an acoustic dipole. The acoustic transducer is configured to radiate sound towards a designated area. The acoustic dipole includes a first housing, and a first sound emitting unit and a second sound emitting unit. There is a phase difference between the sounds radiated by the first sound emitting unit and the second sound emitting unit. The acoustic transducer and the acoustic dipole work together, allowing vector superposition of sound in the target area outside the designated area, maximizing the sound pressure level difference between the designated area and the target area, reducing sound leakage of the headrest audio, achieving better sound zoning or sound isolation effect, and improving user experience.

### CROSS REFERENCE TO RELATED APPLICATIONS

The present application is a continuation of PCT patent application No. PCT/CN2024/129429, entitled “HEADREST FOR PROVIDING INDEPENDENT SOUND ZONES”, filed on Nov. 1, 2024, which is incorporated herein by reference to its entirety.

### TECHNICAL FIELD

The present disclosure belongs to the technical field of automobile accessories, and in particular relates to a headrest for providing independent sound zones.

### BACKGROUND

At present, as the degree and breadth of the intelligence of automobile cabin are improving, the audio system, as an important part of the in-vehicle entertainment system, becomes a major concern of consumers. More and more models of automobiles are equipped with headrest audio, which not only provides better near-field surround effects, but also provides a certain degree of independent navigation, communication, voice interaction and other functions especially for the passenger in the driver's seat. It can be said that headrest audio will gradually become a standard feature of intelligent cabins.

In the related art, one of the original intentions of designing the headrest audio is to provide passengers with relatively independent and private sound zones. However, the conventional design schemes cannot achieve good sound zoning or sound isolation effect, resulting in poor user experience.

Therefore, it is desirable to provide a new headrest for providing independent sound zones.

### SUMMARY

It is an objective of the present disclosure to provide a headrest for providing independent sound zones that can solve the technical problem of poor privacy of in-vehicle headrests in related technologies.

The technical solution of the present disclosure is as follows.

A headrest for providing independent sound zones includes a headrest body and a sound radiation system housed within the headrest body. The sound radiation system includes an acoustic transducer and an acoustic dipole fixed to the headrest body and arranged independently of each other. The acoustic transducer is configured to radiate sound towards a designated area, and the acoustic dipole includes a first housing fixed to the headrest body, and a first sound emitting unit and a second sound emitting unit fixed inside the first housing and spaced apart from each other. Each of the first sound emitting unit and the second sound emitting unit is configured to radiate sound in at least two directions, and there is a phase difference between the sounds radiated by the first sound emitting unit and the second sound emitting unit.

In some embodiments, the first sound emitting unit, the second sound emitting unit, and the first housing together define a first rear cavity.

The first sound emitting unit and the second sound emitting unit are both sound generators, and there is a phase difference between the vibrations of the first sound emitting unit and the second sound emitting unit; or,
one of the first sound emitting unit and the second sound emitting unit is a sound generator, and the other is a passive radiation diaphragm.

The first sound emitting unit and the first housing jointly define a second rear cavity, and the second sound emitting unit and the first housing jointly define a third rear cavity, where the second rear cavity and the third rear cavity are not communicated to each other.

The acoustic transducer includes a second housing fixed to the headrest body and a third sound emitting unit fixed inside the second housing, where the third sound emitting unit is configured to radiate sound towards the designated area.

Only one third sound emitting unit is provided, and the third sound emitting unit and the second housing jointly define a fourth rear cavity; or,
a plurality of third sound emitting units are provided, and the plurality of third sound emitting units and the second housing jointly define a fourth rear cavity; or,
a plurality of third sound emitting units are provided, and the plurality of third sound emitting units and the second housing jointly define a plurality of fourth rear cavities which are not communicated to each other.

A plurality of third sound emitting units are provided, and the plurality of third sound emitting units are distributed in an array.

A shape of the array of third sound emitting units may be any one of a long strip shape, a circular shape, and a rectangular shape.

Only one acoustic transducer is provided, and two acoustic dipoles are provided, where the acoustic transducer is disposed between the two acoustic dipoles; or,
two acoustic transducers are provided, and only one acoustic dipole is provided, where the acoustic dipole is disposed between the two acoustic transducers.

The headrest body is provided with a first sound outlet through hole, a second sound outlet through hole, and a third sound outlet through hole. The first sound outlet through hole is located on a sound emitting side of the acoustic transducer, the second sound outlet through hole is located on a sound emitting side of the first sound emitting unit, and the third sound outlet through hole is located on a sound emitting side of the second sound emitting unit.

The present disclosure has the following beneficial effects. The acoustic transducer can radiate sound towards a designated area, allowing the sound to be replayed in the designated area. Each of the first sound emitting unit and the second sound emitting unit of the acoustic dipole can radiate sound in at least two directions, allowing the acoustic dipole to radiate sound towards a target area outside the designated area. When the directional radiation effect of the acoustic transducer radiating sound towards the designated area is poor, the first sound emitting unit and the second sound emitting unit can be controlled to radiate sound towards the target area outside the designated area, allowing vector superposition of sound in the target area outside the designated area, maximizing the sound pressure level difference between the designated area and the target area, reducing sound leakage of the headrest audio, achieving better sound zoning or sound isolation effect, and improving user experience.

### BRIEF DESCRIPTION OF THE DRAWINGS

FIG. 1 is a schematic diagram of a headrest for providing independent sound zones installed in the driver's seat of an automobile, provided according to an embodiment of the present disclosure;

FIG. 2 is a left view of one acoustic transducer and two acoustic dipoles of the headrest for providing independent sound zones, provided according to an embodiment of the present disclosure;

FIG. 3 is a cross-sectional view of FIG. 2, taken along line A-A;

FIG. 4 is a left view of two acoustic transducers and one acoustic dipole of the headrest for providing independent sound zones, provided according to an embodiment of the present disclosure;

FIG. 5 is a cross-sectional view of FIG. 4, taken along line B-B;

FIG. 6 is a structural schematic diagram of the sound dipole of the headrest for providing independent sound zones, provided according to an embodiment of the present disclosure;

FIG. 7 is a cross-sectional view of FIG. 6 taken along line C-C, where the first sound emitting unit and the second sound emitting unit are sound generators and share the same rear cavity;

FIG. 8 is a cross-sectional view of FIG. 6 taken along line C-C, where the first sound emitting unit is a sound generator, the second sound emitting unit is a passive radiation diaphragm, and the two share the same rear cavity;

FIG. 9 is a cross-sectional view of FIG. 6 taken along line C-C, where the first sound emitting unit and the second sound emitting unit are sound generators and use independent rear cavities;

FIG. 10 is a structural schematic diagram of the acoustic transducer of the headrest for providing independent sound zones provided according to an embodiment of the present disclosure, where the acoustic transducer is provided with three third sound emitting units;

FIG. 11 is a cross-sectional view of FIG. 10 taken along line D-D, where the three third sound emitting units share the same rear cavity;

FIG. 12 is a cross-sectional view of FIG. 10 taken along line D-D, where the three third sound emitting units use independent rear cavities;

FIG. 13 is a schematic diagram of the first sound emitting unit of the acoustic dipole radiating sound to different positions in the automobile; and

FIG. 14 is a schematic diagram of the second sound emitting unit of the acoustic dipole radiating sound to different positions in the automobile.

### DETAILED DESCRIPTION OF THE EMBODIMENTS

The present disclosure will be further described below in combination with the accompanying drawings and embodiments.

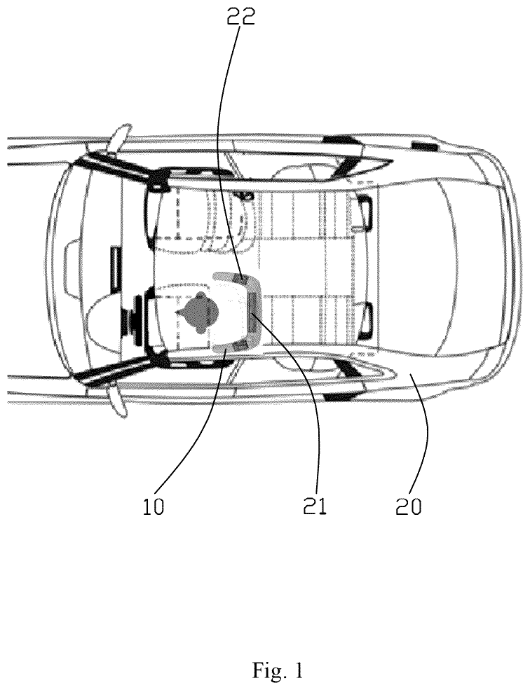

Referring to FIG. 1, the headrest 10 for providing independent sound zones according to the present disclosure can be applied to a seat of an automobile 20, and can be installed in the driver's seat. The headrest 10 for providing independent sound zones can radiate sound towards a designated area, and can also radiate sound towards a target area outside the designated area. In a specific example, the designated area refers to the driver's seat, and the target area refers to the front passenger seat, the left rear seat, and the right rear seat.

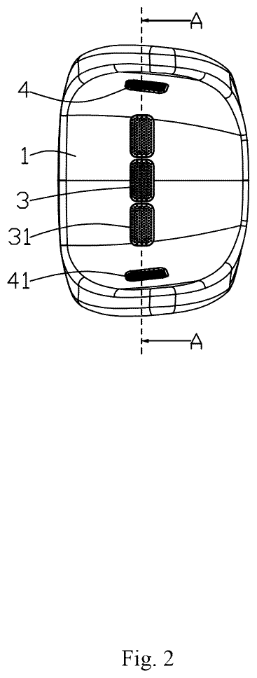

Referring to FIGS. 2 to 12, the headrest 10 for providing independent sound zones according to the present disclosure includes a headrest body 1 and a sound radiation system 2 housed within the headrest body 1. The sound radiation system 2 includes an acoustic transducer 21 and an acoustic dipole 22 fixed to the headrest body 1 and arranged independently of each other. The acoustic transducer 21 is configured to radiate sound towards a designated area, and the acoustic dipole 22 includes a first housing 221 fixed to the headrest body 1, and a first sound emitting unit 222 and a second sound emitting unit 223 fixed inside the first housing 221 and spaced apart from each other. Each of the first sound emitting unit 222 and the second sound emitting unit 223 is configured to radiate sound in at least two directions, and there is a phase difference between the sounds radiated by the first sound emitting unit 222 and the second sound emitting unit 223.

The acoustic transducer 21 can radiate sound towards a designated area, allowing the sound to be replayed in the designated area. Each of the first sound emitting unit 222 and the second sound emitting unit 223 of the acoustic dipole 22 can radiate sound in at least two directions, allowing the acoustic dipole 22 to radiate sound towards a target area outside the designated area. When the directional radiation effect of the acoustic transducer 21 radiating sound towards the designated area is poor, the first sound emitting unit 222 and the second sound emitting unit 223 can be controlled to radiate sound towards the target area outside the designated area, allowing vector superposition of sound in the target area outside the designated area, maximizing the sound pressure level difference between the designated area and the target area, reducing sound leakage of the headrest audio, achieving better sound zoning or sound isolation effect, and improving user experience.

It should be noted that using the acoustic transducer 21 to control the directionality of sound can achieve directional radiation of sound from the acoustic transducer 21 towards the target area. The directional control effect of the acoustic transducer 21 radiating sound is related to the frequency of the sound. The higher the frequency, the better the directional control effect, and the more concentrated the radiation of sound energy. The lower the frequency, the worse the directional control effect, and the more divergent the radiation of sound energy. When the acoustic transducer 21 cannot achieve a good sound directional radiation effect through directional control, the acoustic dipole 22 can be used to perform vector superposition control on the sound radiated to the target area outside the designated area to maximize the sound pressure level difference between different areas, thereby achieving playback of sound in full frequency domain in the designated area and reducing sound leakage of the headrest audio.

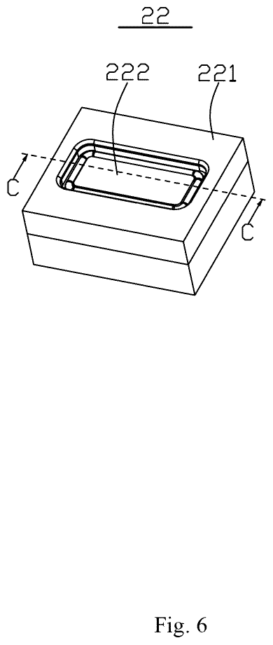

Referring to FIGS. 6 to 9, in the embodiments of the present disclosure, the acoustic dipole 22 may include one first sound emitting unit 222 and one second sound emitting unit 223, or may include a plurality of first sound emitting units 222 and a plurality of second sound emitting units 223. The first sound emitting unit 222 and the second sound emitting unit 223 are arranged to oppose each other and are close to each other. The phase difference between the sounds radiated by the first sound emitting unit 222 and the second sound emitting unit 223 may be due to a certain difference between the vibration phases of the sound generators. For example, there may be a certain phase difference or delay in the input signals input to the first sound emitting unit 222 and the second sound emitting unit 223. Alternatively, the phase difference may be achieved through a passive implementation method using physical structure design, such as providing opposite inverter tubes in the front and rear cavities, passive radiation diaphragm, and sound wave guide tube. The first sound emitting unit 222 and the second sound emitting unit 223 may share the same rear cavity, or they may use independent rear cavities.

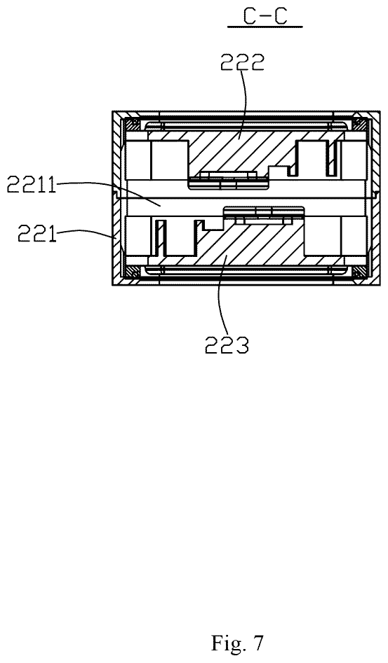

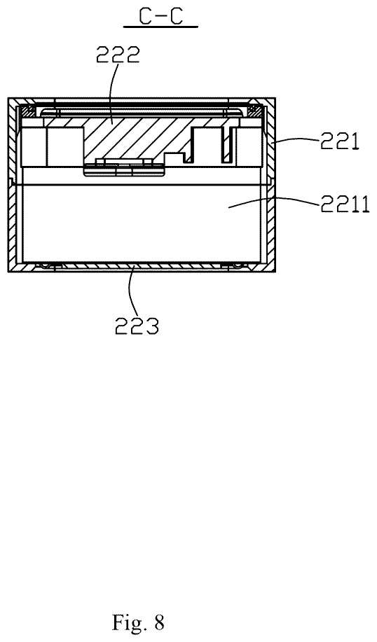

Referring to FIGS. 7 and 8, in some embodiments, the first sound emitting unit 222, the second sound emitting unit 223, and the first housing 221 jointly define a first rear cavity 2211, that is, the first sound emitting unit 222 and the second sound emitting unit 223 share the same rear cavity. Thus, the structure of the acoustic dipole 22 is relatively simple. The first sound emitting unit 222 and the second sound emitting unit 223 may be sound generators, such as moving-coil speaker, electrostatic speaker, MEMS speaker or speaker module.

The following is an example of the configuration in which there is a phase difference between the sounds radiated by the first sound emitting unit 222 and the second sound emitting unit 223.

Referring to FIG. 7, in a specific example, the phase difference between the sounds radiated by the first sound emitting unit 222 and the second sound emitting unit 223 may be due to a certain difference between the vibration phases of the sound generators. For example, the first sound emitting unit 222 and the second sound emitting unit 223 are both sound generators, and there is a certain phase difference or delay in the input signals input to the first sound emitting unit 222 and the second sound emitting unit 223, leading to a phase difference between the vibrations of the first sound emitting unit 222 and the second sound emitting unit 223.

Referring to FIG. 8, in a specific example, the phase difference between the sounds radiated by the first sound emitting unit 222 and the second sound emitting unit 223 may be achieved through a passive implementation method using physical structure design. For instance, one of the first sound emitting unit 222 and the second sound emitting unit 223 is a sound generator, while the other is a passive radiation diaphragm. Specifically, the first sound emitting unit 222 is a sound generator, and the second sound emitting unit 223 is a passive radiation diaphragm, where the sound generator and the passive radiation diaphragm share the same rear cavity, and the passive radiation diaphragm cannot actively produce sound. When the first sound emitting unit 222 vibrates, the air compression force of the first rear cavity 2211 causes the second sound emitting unit 223 to vibrate passively and radiate sound outwardly. Such physical structure design allows the sounds radiated outwardly by the first sound emitting unit 222 and the second sound emitting unit 223 to be opposite in phase.

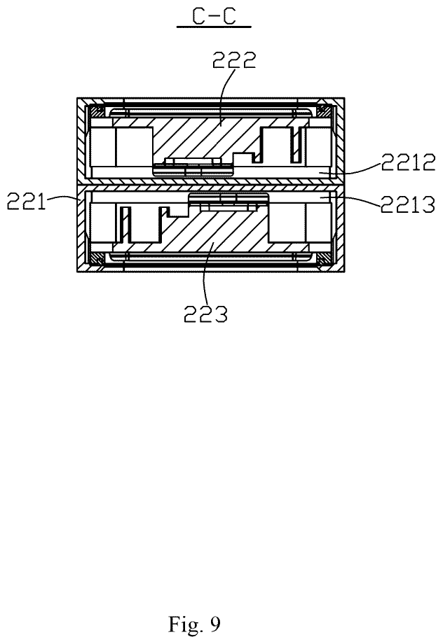

Referring to FIG. 9, in some embodiments, the first sound emitting unit 222 and the first housing 221 jointly define a second rear cavity 2212, and the second sound emitting unit 223 and the first housing 221 jointly define a third rear cavity 2213. The second rear cavity 2212 and the third rear cavity 2213 are not communicated to each other, that is, the first sound emitting unit 222 and the second sound emitting unit 223 use independent rear cavities, and the vibration characteristics of the first sound emitting unit 222 and the second sound emitting unit 223 do not interfere with each other. Moreover, the vibration phases of the first sound emitting unit 222 and the second sound emitting unit 223 can be controlled separately, which is beneficial for accurately adjusting the phase difference between the sounds radiated outwardly by the first sound emitting unit 222 and the second sound emitting unit 223. The first sound emitting unit 222 and the second sound emitting unit 223 may be sound generators, such as moving-coil speaker, electrostatic speaker, MEMS speaker or speaker module.

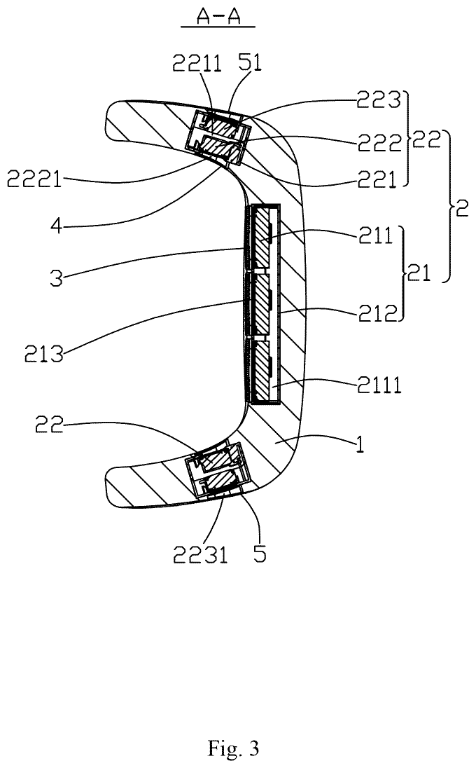

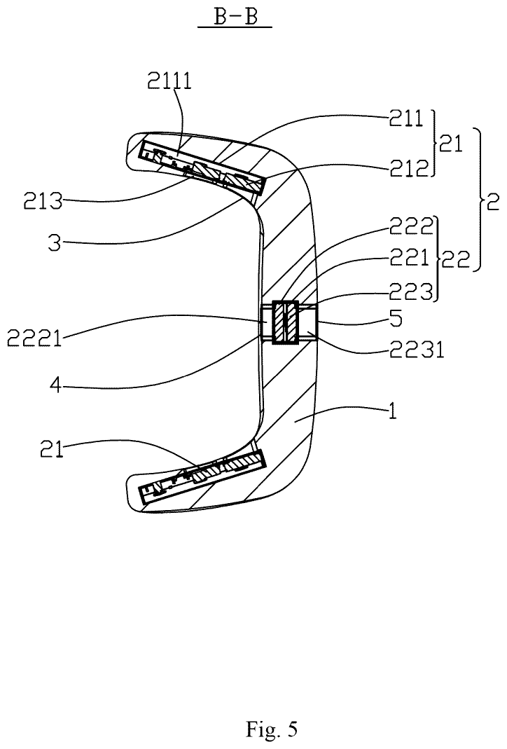

It should be noted that, regardless of the acoustic dipole 22 with independent rear cavities or the acoustic dipole 22 with a shared rear cavity, a first front cavity 2221 of the acoustic dipole 22 may be defined jointly by the first sound emitting unit 222 and the first housing 221, as shown in FIG. 3 and FIG. 5, or jointly by the first sound emitting unit 222, the first housing 221, and the headrest body 1. A second front cavity 2231 of the acoustic dipole 22 may be defined jointly by the second sound emitting unit 223 and the first housing 221, as shown in FIGS. 3 and 5, or jointly by the second sound emitting unit 223, the first housing 221, and the headrest body 1.

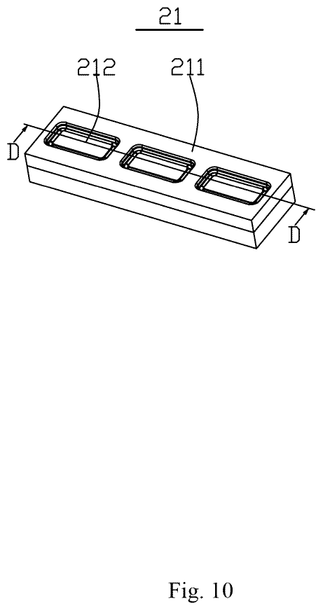

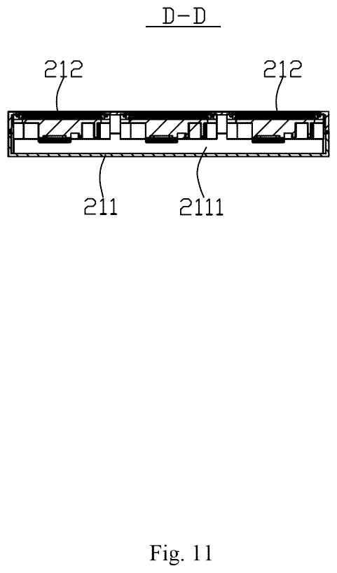

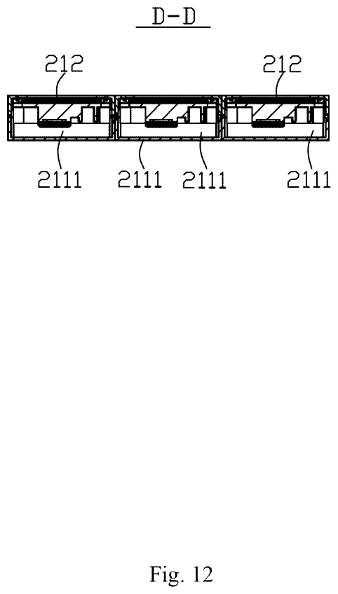

Referring to FIG. 10, FIG. 11 and FIG. 12, the acoustic transducer 21 includes a second housing 211 fixed to the headrest body 1 and a third sound emitting unit 212 fixed inside the second housing 211. The third sound emitting unit 212 is configured to radiate sound towards the designated area. The third sound emitting unit 212 may be a transducer that converts electrical signals into acoustic signals for radiation, such as moving-coil speaker, electrostatic speaker, MEMS speaker or speaker module. One or more third sound emitting units 212 may be provided. When the transducer itself has strong directional characteristics, only one third sound emitting unit 212 may be provided. When the directional characteristics of the transducer itself are poor, a plurality of third sound emitting units 212 may be provided, where the plurality of third sound emitting units 212 are distributed in an array, and a shape of the array of third sound emitting units 212 may be any one of a long strip shape, a circular shape, and a rectangular shape.

The following provides an example of the configuration of the acoustic transducer 21.

In a specific example, only one third sound emitting unit 212 is provided, and the third sound emitting unit 212 and the second housing 211 jointly define a fourth rear cavity 2111. In this case, the transducer of the third sound emitting unit 212 has prominent directional characteristics.

Referring to FIG. 11, in a specific example, a plurality of third sound emitting units 212 are provided, and the plurality of third sound emitting units 212 and the second housing 211 jointly define the fourth rear cavity 2111, that is, the acoustic transducer 21 shares the same rear cavity. Thus, the structure of the acoustic transducer is simple. For example, three third sound emitting units 212 are provided, and the three third sound emitting units 212 and the second housing 211 jointly define the fourth rear cavity 2111, and the three third sound emitting units 212 are in a long strip array.

Referring to FIG. 12, in a specific example, a plurality of third sound emitting units 212 are provided, and the plurality of third sound emitting units 212 and the second housing 211 jointly define a plurality of fourth rear cavities 2111. The plurality of fourth rear cavities 2111 are not communicated to each other, that is, the three third sound emitting units 212 of the acoustic transducer 21 use independent rear cavities, and the vibration characteristics of the three third sound emitting units 212 do not interfere with each other. For example, three third sound emitting units 212 are provided, and the three third sound emitting units 212 and the second housing 211 jointly define three fourth rear cavities 2111. The three fourth rear cavities 2111 are not communicated to each other, and the three third sound emitting units 212 are in a long strip array.

It should be noted that, regardless of the acoustic transducer 21 with independent rear cavities or the acoustic transducer 21 with a shared rear cavity, the rear cavity thereof may be defined jointly by the third sound emitting unit 212 and the second housing 211, as shown in FIG. 3 and FIG. 5, or jointly by the third sound emitting unit 212, the second housing 211, and the headrest body 1. Moreover, a third front cavity 213 of the acoustic transducer 21 may be defined jointly by the third sound emitting unit 212 and the second housing 211, as shown in FIGS. 3 and 5, or jointly by the third sound emitting unit 212, the second housing 211, and the headrest body 1, which is not specifically limited herein.

Referring to FIGS. 2 to 5, in the embodiments of the present disclosure, the arrangement positions of the acoustic transducer 21 and the acoustic dipole 22 on the headrest body 1 may be adjusted according to the actual design situation.

Referring to FIG. 2 and FIG. 3, in a specific example, only one acoustic transducer 21 is provided, and two acoustic dipoles 22 are provided, where the acoustic transducer 21 is disposed between the two acoustic dipoles 22.

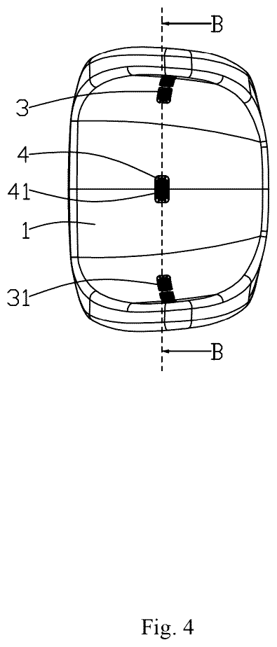

Referring to FIG. 4 and FIG. 5, in a specific example, two acoustic transducers 21 are provided, and only one acoustic dipole 22 is provided, where the acoustic dipole 22 is disposed between the two acoustic transducers 21.

Referring to FIGS. 2 and 3, the headrest body 1 is provided with a first sound outlet through hole 31, a second sound outlet through hole 41, and a third sound outlet through hole 51. The first sound outlet through hole 31 is located on a sound emitting side of the acoustic transducer 21, allowing the acoustic transducer 21 to radiate sound outwardly through the first sound through-hole 31. The second sound outlet through hole 41 is located on a sound emitting side of the first sound emitting unit 222, allowing the first sound emitting unit 222 to radiate sound outwardly through the second sound outlet through hole 41. The third sound outlet through hole 51 is located on a sound emitting side of the second sound emitting unit 223, allowing the second sound emitting unit 223 to radiate sound outwardly through the third sound outlet through hole 51. The sound emitting side of the first sound emitting unit 222 and the sound emitting side of the second sound emitting unit 223 are disposed on opposite sides of the headrest body 1.

According to actual needs, as shown in FIGS. 2 to 5, the surface of the headrest body 1 is provided with a first mesh cover 3, a second mesh cover 4, and a third mesh cover 5. The first mesh cover 3 is disposed on the sound emitting side of the acoustic transducer 21, and the first sound outlet through hole 31 is disposed on the first mesh cover 3. The second mesh cover 4 is disposed on the sound emitting side of the first sound emitting unit 222, and the second sound outlet through hole 41 is disposed on the second mesh cover 4. The third mesh cover 5 is disposed on the sound emitting side of the second sound emitting unit 223, and the third sound outlet through hole 51 is disposed on the third mesh cover 5.

It should be understood that the directional control of sound using the acoustic transducer 21 enables the sound emitted by the acoustic transducer 21 to be directed towards the user in the driver's seat. xy plane is used to explain the sound radiation characteristics of the acoustic transducer 21 after directional control. The sound radiates the least energy in the x-axis direction, radiates medium energy in the direction between the x-axis and y-axis, and radiates the most energy in the y-axis direction. The user is located in the y-axis direction of the headrest 10 for providing independent sound zones, so that performing directional control on the acoustic transducer 21 to focus the sound it radiates mainly in the y-axis direction can achieve directional radiation of sound and thus achieve playback of sound in a designated area.

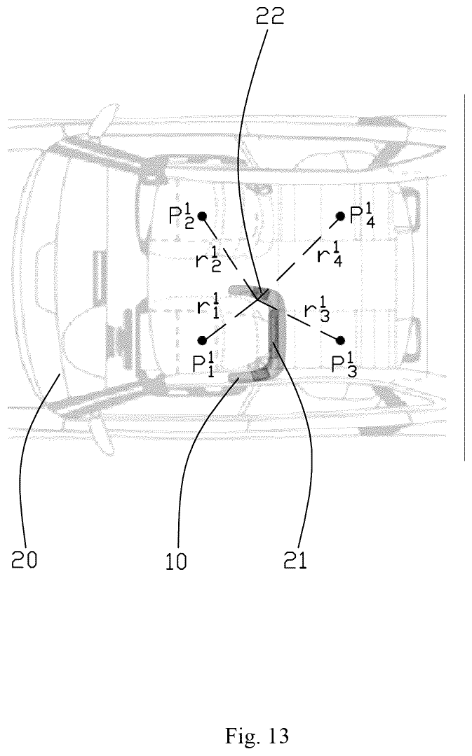

The acoustic dipole 22 can radiate sound towards the driver's seat, the front passenger seat, the left rear seat, and the right rear seat. As shown in FIG. 13, FIG. 13 is a schematic diagram of the first sound emitting unit 222 of the acoustic dipole 22, in the headrest 10 for providing independent sound zones, radiating sound to different positions in the automobile. Taking the acoustic dipole 22 located on the left side as an example, the sound emitting side of the first sound emitting unit 222 faces the inside of the headrest 10 for providing independent sound zones, and the sounds radiated by the sound emitting side of the first sound emitting unit 222 towards the four positions in the automobile are P₁¹, P₂¹, P₃¹, and P₄¹, respectively. Then, the sounds at time t can be represented as follows:

$$\{ \begin{matrix}{P}_{1}^{1} = \frac{{A}_{1}}{{r}_{1}^{1}} {e}^{j ( ω t - {kr}_{1}^{1} + {φ}_{1} )} \\ {P}_{2}^{1} = \frac{{A}_{1}}{{r}_{2}^{1}} {e}^{j ( ω t - {kr}_{2}^{1} + {φ}_{1} )} \\ {P}_{3}^{1} = \frac{{A}_{1}}{{r}_{3}^{1}} {e}^{j ( ω t - {kr}_{3}^{1} + {φ}_{1} )} \\ {P}_{4}^{1} = \frac{{A}_{1}}{{r}_{4}^{1}} {e}^{j ( ω t - {kr}_{4}^{1} + {φ}_{1} )}\end{matrix} ;$$

where A₁ represents the intensity of the sound emitted from the sound emitting side of the acoustic dipole 22;

$${r}_{1}^{1} , {r}_{2}^{1} , {r}_{3}^{1} , and {r}_{4}^{1}$$

represent the sound propagation distances from the sound emitting side of the acoustic dipole 22 to the driver's seat, front passenger seat, left rear seat, and right rear seat in the automobile, respectively; ω represents the angular frequency of the radiated sound; k represents the wave number of the radiated sound, k=ω/c, and c represents the speed of sound; φ₁ represents the initial phase of the sound radiated outwardly by the first sound emitting unit 222 in the left acoustic dipole 22; e represents the natural constant; and j represents the imaginary unit.

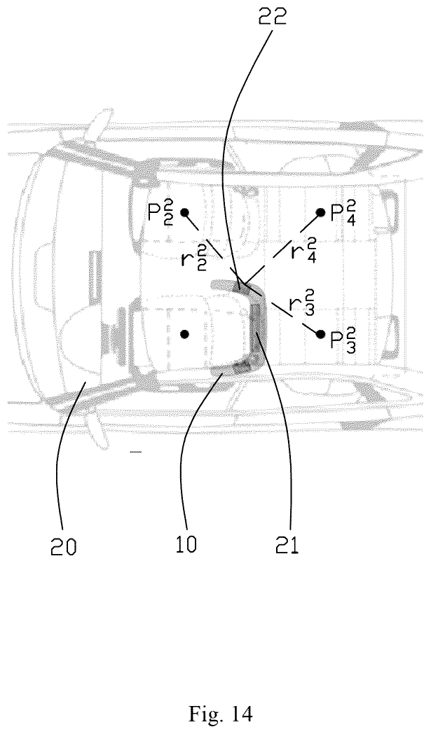

Further taking the left acoustic dipole 22 as an example, as shown in FIG. 14, FIG. 14 is a schematic diagram of the second sound emitting unit 223 of the acoustic dipole 22, in the headrest 10 for providing independent sound zones, radiating sound to different positions in the automobile. The sound emitting side of the second sound emitting unit 223 faces the outside of the headrest 10 for providing independent sound zones. Because the sound emitted by the sound emitting side of the second sound emitting unit 223 is blocked by the headrest 10 for providing independent sound zones, the sound propagated to the driver's seat is much weaker than the sound emitted by the sound emitting side of the first sound emitting unit 222 to the driver's seat. Further, the driver's seat is very close to the sound emitting side of the first sound emitting unit 222, so the sound at the driver's seat is mainly affected by the sound radiated by the first sound emitting unit 222. Therefore, the sounds radiated by the sound emitting side of the second sound emitting unit 223 towards different positions in the automobile are P₂², P₃², and P₄², respectively. Then, the sounds at time t can be represented as follows:

$$\{ \begin{matrix}{P}_{2}^{2} = \frac{{A}_{2}}{{r}_{2}^{2}} {e}^{j ( ω t - {kr}_{2}^{2} + {φ}_{2} )} \\ {P}_{3}^{2} = \frac{{A}_{2}}{{r}_{3}^{2}} {e}^{j ( ω t - {kr}_{3}^{2} + {φ}_{2} )} \\ {P}_{4}^{2} = \frac{{A}_{2}}{{r}_{4}^{2}} {e}^{j ( ω t - {kr}_{4}^{2} + {φ}_{2} )}\end{matrix} ;$$

where A₂ represents the intensity of the sound emitted from the sound emitting side of the second sound emitting unit 223;

$${r}_{2}^{2} , {r}_{3}^{2} , and {r}_{4}^{2}$$

represent the sound propagation distances from the sound emitting side of the second sound emitting unit 223 to the front passenger seat, left rear seat, and right rear seat in the automobile, respectively; φ₂ represents the initial phase of the sound radiated outwardly by the second sound emitting unit 223 in the left acoustic dipole 22.

It should be understood that by controlling the different sound signals fed to the first sound emitting unit 222 and the second sound emitting unit 223 of the left acoustic dipole 22, A₁, A₂, φ₁, and φ₂ can be controlled such that P₁¹ meets normal listening requirements while satisfying the optimal solution of the following conditions:

$$\{ \begin{matrix}\vert {P}_{2}^{1} + {P}_{2}^{2} \vert = 0 \\ \vert {P}_{3}^{1} + {P}_{3}^{2} \vert = 0 \\ \vert {P}_{4}^{1} + {P}_{4}^{2} \vert = 0\end{matrix} ;$$

where, | [symbol] | represents the modulo operation. It should be understood that when the optimal solution satisfying the above conditions is achieved, the playback of sound in full frequency domain at the driver's seat can be achieved, preventing the sound from leaking to the front passenger seat, left rear seat, and right rear seat.

It should be noted that the sound radiation principle of the right acoustic dipole 22 is the same as that of the left acoustic dipole 22, and therefore is not repeated here.

The above description only shows embodiments of the present disclosure. It should be noted herein that for those skilled in the art, improvements may be made without departing from the inventive concept of the present disclosure, and those improvements still fall within the scope of protection of the present disclosure.

What is claimed is:

1. A headrest for providing independent sound zones, comprising a headrest body and a sound radiation system housed within the headrest body, wherein the sound radiation system comprises an acoustic transducer and an acoustic dipole fixed to the headrest body and arranged independently of each other, the acoustic transducer is configured to radiate sound towards a designated area, wherein the acoustic dipole comprises a first housing fixed to the headrest body, and a first sound emitting unit and a second sound emitting unit fixed inside the first housing and spaced apart from each other, wherein each of the first sound emitting unit and the second sound emitting unit is configured to radiate sound in at least two directions, and there is a phase difference between the sounds radiated by the first sound emitting unit and the second sound emitting unit.

2. The headrest for providing independent sound zones according to claim 1, wherein the first sound emitting unit, the second sound emitting unit, and the first housing together define a first rear cavity.

3. The headrest for providing independent sound zones according to claim 2, wherein the first sound emitting unit and the second sound emitting unit are both sound generators, and there is a phase difference between vibrations of the first sound emitting unit and the second sound emitting unit; or,
one of the first sound emitting unit and the second sound emitting unit is a sound generator, and the other is a passive radiation diaphragm.

4. The headrest for providing independent sound zones according to claim 1, wherein the first sound emitting unit and the first housing jointly define a second rear cavity, the second sound emitting unit and the first housing jointly define a third rear cavity, wherein the second rear cavity and the third rear cavity are not communicated to each other.

5. The headrest for providing independent sound zones according to claim 1, wherein the acoustic transducer comprises a second housing fixed to the headrest body and a third sound emitting unit fixed inside the second housing, wherein the third sound emitting unit is configured to radiate sound towards the designated area.

6. The headrest for providing independent sound zones according to claim 5, wherein only one third sound emitting unit is provided, and the only one third sound emitting unit and the second housing jointly define a fourth rear cavity; or,
a plurality of third sound emitting units are provided, and the plurality of third sound emitting units and the second housing jointly define a fourth rear cavity; or,
a plurality of third sound emitting units are provided, and the plurality of third sound emitting units and the second housing jointly define a plurality of fourth rear cavities which are not communicated to each other.

7. The headrest for providing independent sound zones according to claim 5, wherein a plurality of third sound emitting units are provided, and the plurality of third sound emitting units are distributed in an array.

8. The headrest for providing independent sound zones according to claim 7, wherein a shape of the array of third sound emitting units is any one of a long strip shape, a circular shape, and a rectangular shape.

9. The headrest for providing independent sound zones according to claim 1, wherein only one acoustic transducer is provided, and two acoustic dipoles are provided, wherein the only one acoustic transducer is disposed between the two acoustic dipoles; or,
two acoustic transducers are provided, and only one acoustic dipole is provided, wherein the only one acoustic dipole is disposed between the two acoustic transducers.

10. The headrest for providing independent sound zones according to claim 1, wherein the headrest body is provided with a first sound outlet through hole, a second sound outlet through hole, and a third sound outlet through hole, wherein the first sound outlet through hole is located on a sound emitting side of the acoustic transducer, the second sound outlet through hole is located on a sound emitting side of the first sound emitting unit, and the third sound outlet through hole is located on a sound emitting side of the second sound emitting unit.
